(19) United States
(12) Patent Application Publication
(10) Pub. No.: US 2006/0138162 A1
(43) Pub. Date: Jun. 29, 2006

(54) Dispenser

(75) Inventors: Gregor John McLenan Anderson, Hertfordshire (GB); James Terence Collins, Cambridgeshire (GB); Ralph George Lamble, Cambridgeshire (GB); Allen John Pearson, Cambridgeshire (GB); Tom Snow, Cambridgeshire (GB); Paul John Turner, Cambridgeshire (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(73) Assignee: GLAXO GROUP LIMITED

(21) Appl. No.: 10/561,375

(22) PCT Filed: Jul. 9, 2004
(86) PCT No.: PCT/EP04/07808

§ 371 Date: Dec. 16, 2005

(30) Foreign Application Priority Data
Jul. 11, 2003 (GB) 0316348.2

(51) Int. Cl. G07F 11/00

(52) U.S. Cl. 221/288

(57) ABSTRACT

A hand-held dispenser (1) for dispensing a multiplicity of unit products (3) having a storage area (100) for storing the unit products, an outlet opening (311) through which the unit products are dispensable from the dispenser, a dispensing mechanism (350) actuable to dispense the unit products through the outlet opening, and a dispensing indicator (400) for indicating the number of unit products left in, or dispensed from, the dispenser. The dispensing indicator is integrated with the dispenser such that it is automatically updated in response to the dispensing of the unit products therefrom.

### RELATED APPLICATIONS

The present application claims priority from UK patent application No. 0 316 348.2 filed 11 Jul. 2003, the content of which is incorporated herein by reference.

The present application is related to the three International patent applications filed concurrently herewith by the Applicant (Glaxo Group Limited) under the title ‘A Dispenser’ which respectively claim priority from UK patent application Nos. 0 316 345.8, 0 316 352.4 and 0 316 355.7 all filed on 11 Jul. 2003. The contents of these applications are hereby incorporated herein by reference.

### FIELD OF THE INVENTION

The present invention relates to a dispenser for dispensing unit products, for instance pills, such as pharmaceutical pills. The term “pill” is meant to embrace tablets, capsules and the like, and other solid oral dosage forms, whether pharmaceutical or otherwise.

There is previously known a child-resistant closure cap for a pill bottle which includes a digital display that indicates how many pills have been taken from the bottle in the day and how long ago the last pill was taken that day. The display is reset at the start of the next day. This is known as the MEMS® SmartCap Monitor of Aardex Limited (www.aardex.ch). A drawback of this cap is that it is removed from the pill bottle to enable the patient to access the bottle contents in the normal way, i.e. by tipping of the bottle. The removal of the cap is recorded by the cap and results in the pill count and ‘time-since-last dose’ functions of the display being updated. However, the cap is not capable of recording how many pills are removed from the bottle, if any, upon cap removal. Accordingly, the display may be inaccurate as removal of the cap does not necessarily mean that the patient subsequently removes the number of pills required in the prescribed dosing regime.

### SUMMARY OF THE INVENTION

According to the present invention there is provided a dispenser according to claim 1 hereof.

Other aspects and preferred features of the invention are set out in the other claims (including those in the related applications referred to above) and in the exemplary embodiments hereinafter to be described with reference to the accompanying FIGURES of drawings.

### BRIEF DESCRIPTION OF THE FIGURES OF DRAWINGS

FIG. 1 shows a standard container for containing and dispensing pharmaceutical pills comprising a bottle and a lid.

FIG. 2 shows a hand-held dispenser for pharmaceutical pills according to an embodiment of the present invention comprising the bottle and the lid of FIG. 1 and a dispensing module, the dispensing module being mounted on the bottle and the lid being mounted on the dispensing module.

FIG. 3 shows the dispenser without the lid.

FIGS. 4A and B are side views of the dispensing module.

FIG. 5 is an exploded view of the dispensing module.

FIGS. 6A-C are perspective end views of the dispensing module showing how a battery can be replaced.

FIGS. 7A-E are longitudinal sectional views of the dispensing module illustrating its operation to dispense a pill therefrom and showing the internal channel structure of the module.

FIGS. 8A and B are schematic views of the channel structure in the dispensing module.

FIGS. 9A-C are schematic views illustrating the dispensing of a pill from the dispensing module.

FIGS. 10-C correspond to FIGS. 9A-C, but show the inclusion of switches to control operation of an electronic dose counter of the dispensing module.

FIG. 11 shows the dispenser being pressed against a user's palm to “blot” out a pill therefrom.

FIG. 12 shows a display of the electronic dose counter illustrating the segmented nature thereof.

FIGS. 13A-C are perspective side views of a modified version of the dispenser.

FIGS. 14A and B are perspective exploded views of the lid of the modified dispenser of FIGS. 13A-C.

### DETAILED DESCRIPTION OF THE FIGURES OF DRAWINGS

In the FIGURES of drawings there is shown a hand-held dispenser 1 of the invention for dispensing pills 3, in this embodiment pharmaceutical pills. The dispenser has a container or bottle 100, a lid 200 and a dispensing module 300 releasably mountable on the bottle 100.

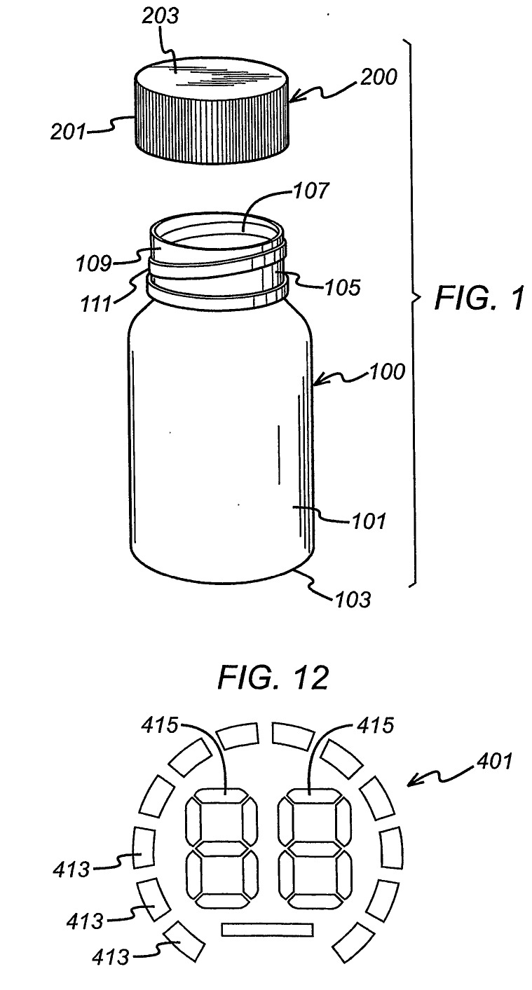

Referring to FIG. 1, the bottle 100 in this embodiment is of standard pill bottle construction, having a hollow body 101 which is formed with a base 103, on which the dispenser 1, when assembled, is able to stand upright, and a neck 105, through which an access opening 107 is provided to the internal volume of the body 101 in which the pills 3 are contained. The access opening 107 is sized so as to enable the pills 3 to be tipped out of the bottle 100.

The body 101 is preferably formed from a plastics material or glass. The plastics material may be a polyethylene, for instance low density polyethylene (LDPE), or polypropylene (PP), for example.

The neck 105 has an outer circumferential surface 109 on which is provided a screw thread profile 111.

The lid 200, which is preferably of a plastics material, has an annular skirt 201 which depends from an end wall 203. The annular skirt 201 has an inner circumferential surface on which is provided a screw thread profile (not shown) which is complementary to the screw thread profile 111 on the bottle neck 105. In this way, the lid 200 is able to be screwed onto the bottle neck 105 to sealingly close the access opening 107. Preferably, the screw fitting between the bottle 100 and the lid 200 is of a child-resistant nature, i.e. a force additional to turning is needed to remove the lid 200 from the bottle 100. As examples, there may be mentioned “squeeze-and-turn” and “push-and-turn” closures.

Of course, other types of co-operable connection structures on the bottle 100 and lid 200 could be used, again preferably being of a child-resistant type, namely requiring two different types of force to be applied for removal of the lid 200 from the bottle 100.

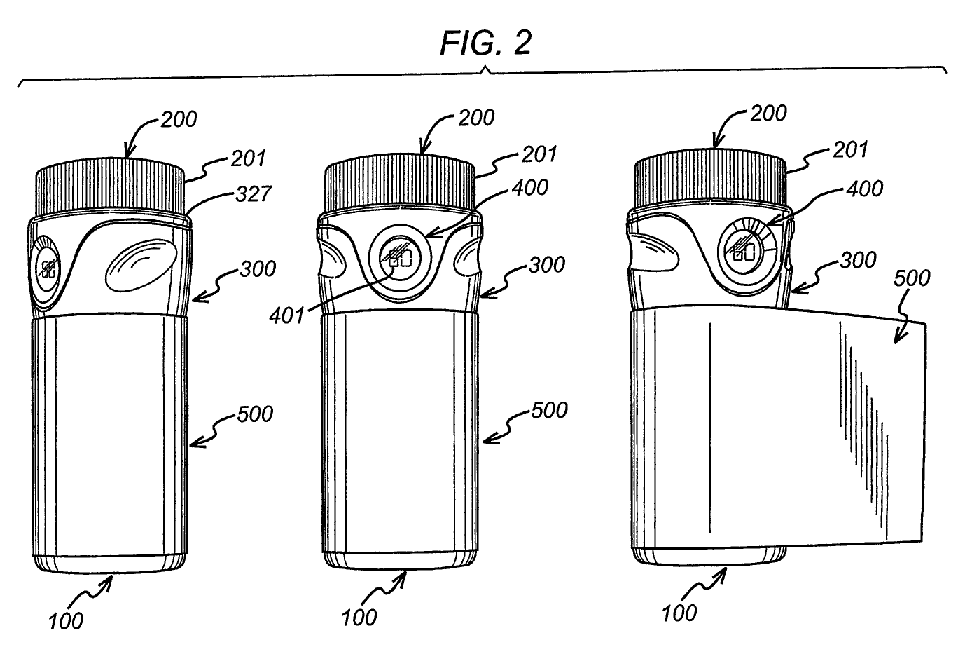

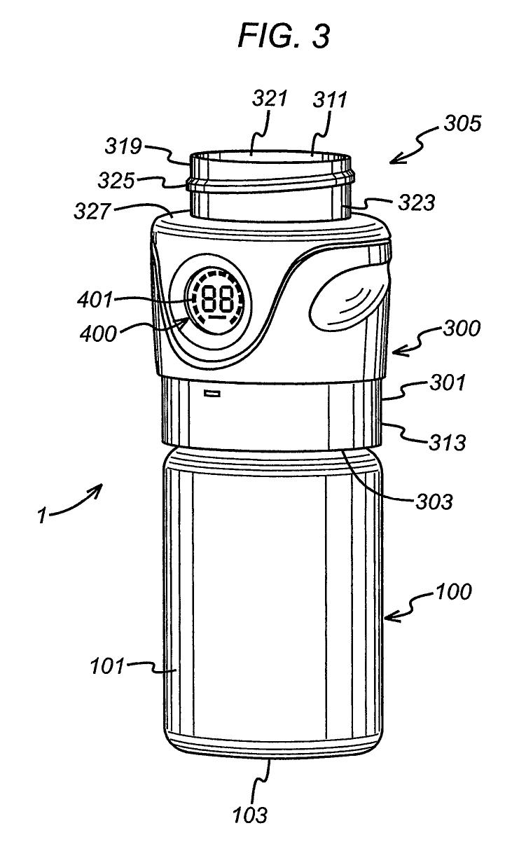

As shown in FIGS. 2-7, the dispensing module 300 has a hollow body 301, which is preferably of a plastics material, having a lower end 303 and an upper end 305. The body 301 has an internal cavity 307 to which there is provided a lower opening 309 in the lower end 303, and an upper opening 311 in the upper end 305.

The lower end 303 defines an annular skirt 313 about the lower opening 309 having an inner circumferential surface 315 on which is provided a first screw thread profile 317 complementary to the screw thread profile 111 on the bottle neck 105. Thus, the dispensing module 300 is able to be screw mounted onto the bottle neck 105, in similar fashion to the lid 200. The first screw thread profile 317 may form a child-resistant connection with the bottle neck screw thread profile 111, and is conveniently identical to the lid screw thread profile.

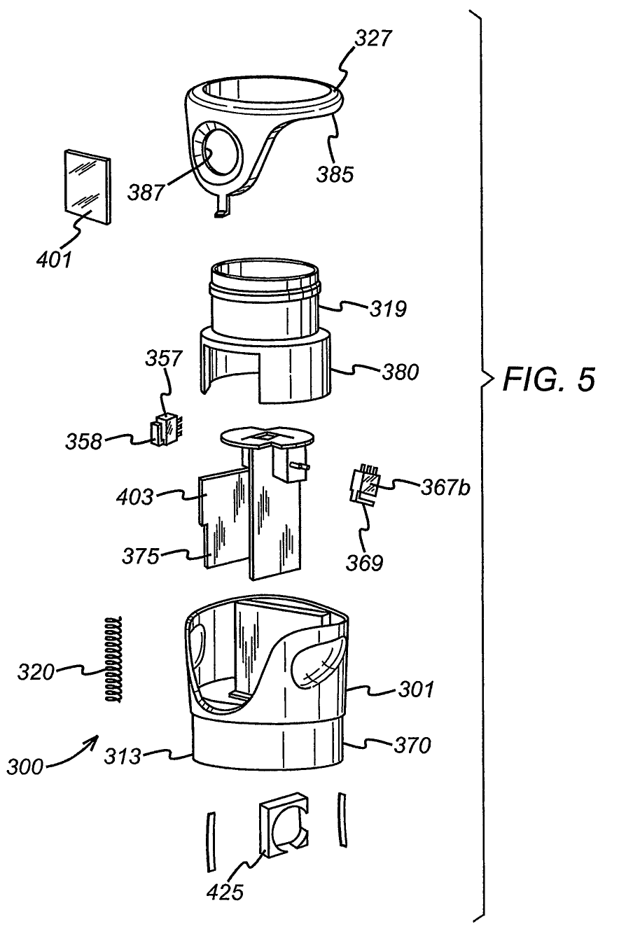

At the module upper end 305 there is located a nozzle 319 of tubular form having a lumen 321 which defines the upper opening 311. The nozzle 319 is arranged for sliding movement in the dispensing module 300 along its longitudinal axis. A spring or other biasing mechanism 320 (see FIG. 5) is provided to bias the nozzle 319 outwardly to a rest position, as shown in FIGS. 2-4, for example.

The nozzle 319 has an outer circumferential surface 323 on which is provided a second screw thread profile 325 of the dispensing module 300. The second screw thread profile 325 is complementary to the lid screw thread profile thereby enabling the lid 200 to be screwed onto the nozzle 319 when in its rest position to close the upper opening 311, as shown in FIG. 2. Moreover, when the lid 200 is mounted on the nozzle 319, the nozzle 319 is unable to be slid inwardly from its rest position through abutment of the lid skirt 201 with an annular shoulder 327 of the dispensing module body 301.

Again, the second screw thread profile 325 preferably co-operates with the lid screw thread profile to form a child-resistant connection. Conveniently, the second screw thread profile 325 is identical to the screw thread profile 111 on the bottle neck 105.

It will therefore be seen that the dispenser 1 enables the lid 200 to be replaced on the bottle 100 by the dispensing module 300 and then in turn mounted on the nozzle 319 to close the upper opening 311 of the module 300 (the “assembled state”). Thus, the dispensing module 300 can be mounted on a standard pill bottle and be closed by the lid for the standard bottle. This is shown in FIG. 2.

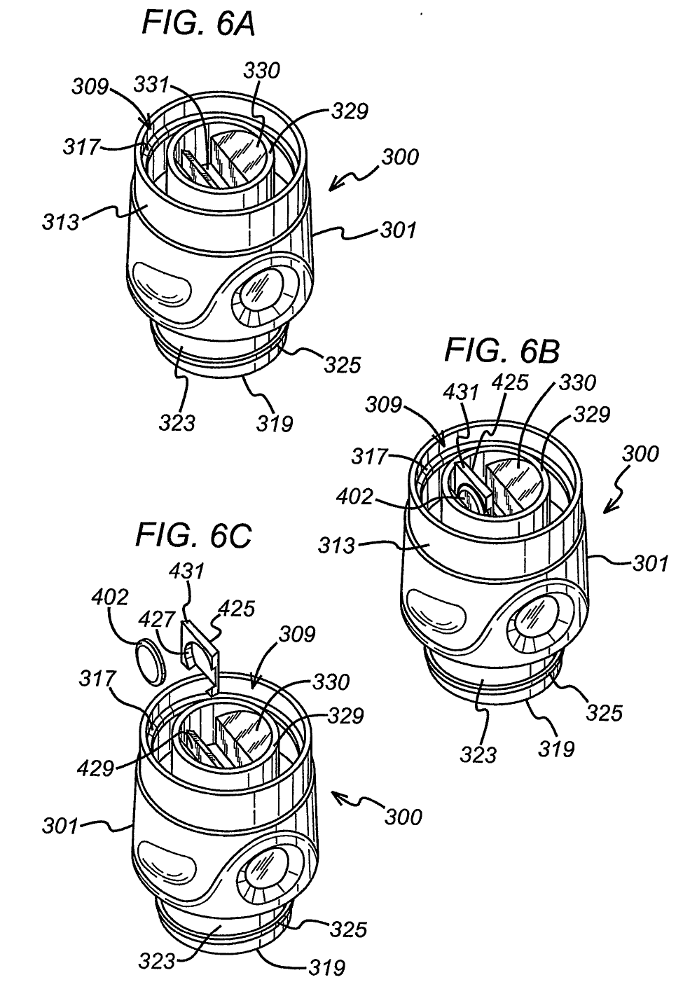

As shown in FIGS. 6-8, the module internal cavity 307 has a funnel-like configuration, having a cylindrical entrance 329 at the lower opening 309, with tapered sides 330, and a generally rectangular slot 331, which extends towards the upper opening 311 through the lumen 321 of the nozzle 319.

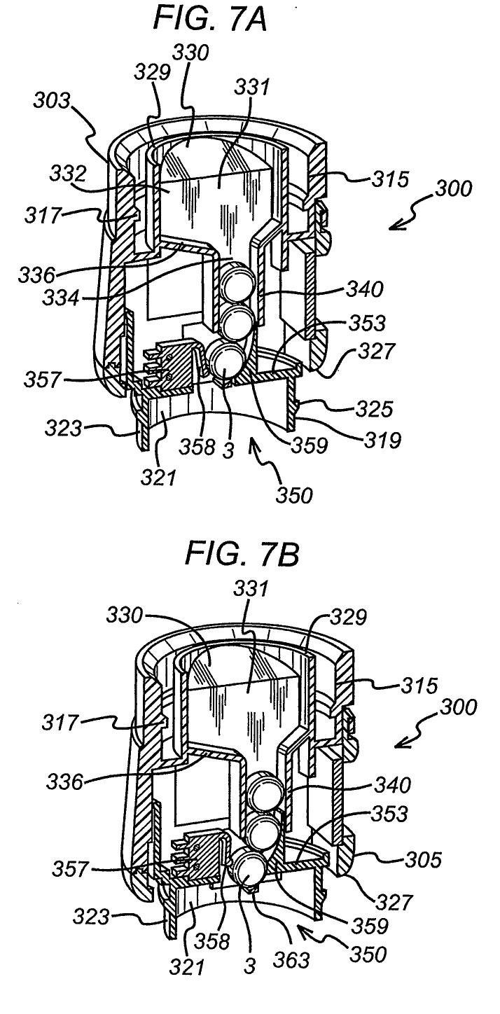

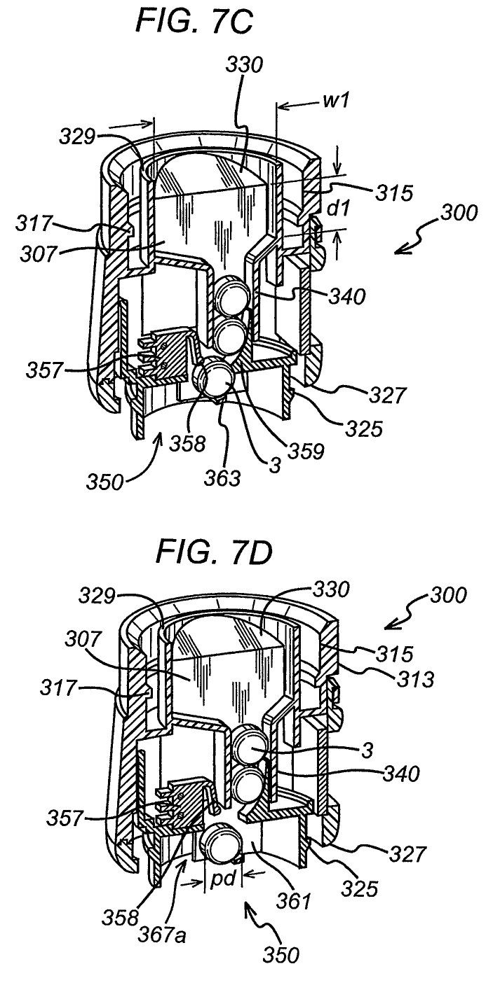

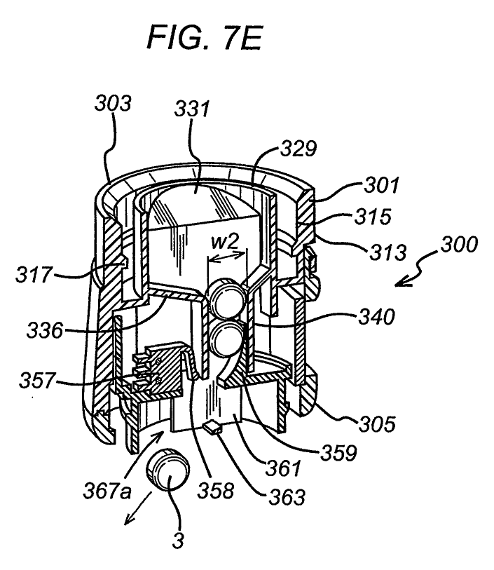

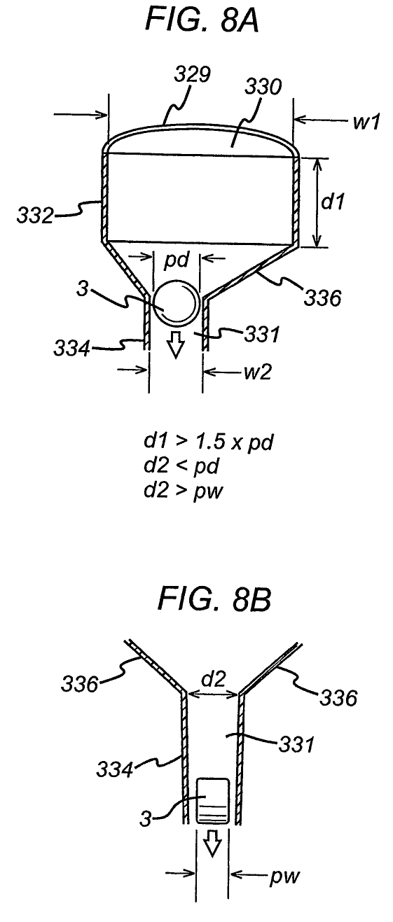

As shown in FIGS. 7 and 8, the slot 331 has a lower section 332 of a first width w1, which is greater than the diameter pd of the pills 3, and an upper section 334 of a second width w2 less than the first width w1, but greater than the pill diameter pd, but less than twice the pill diameter pd. The upper slot section 334 is offset to the lower slot section 332. Moreover, the lower slot section 332 has a base surface 336 which tapers in the upward direction.

When the dispenser 1 is inverted in its assembled state, the pills 3 are gravity fed from the bottle 100 into the dispensing module 300 through the communicating access and lower openings 107,309. The pills 3 so transferred into the dispensing module 300 are funnelled firstly by the tapered sides 330 into the lower slot section 332. In this regard, the tapered sides 330 act to funnel the pills 3 into the slot 331 in the same predetermined orientation. In this embodiment, the pills 3 are circular and funnelled into the slot 331 in a radial orientation so that they are arranged circumference-to-circumference in the slot 331.

The pills are then gravity fed into the upper slot section 334 by the tapered base surface 336 of the lower slot section 332. In this way, a single-line queue 333 of pills 3 is formed in the upper slot section 334, as shown in FIG. 7, for example.

Preferably, the lower and upper slot sections 332,334 have dimensions relative to the pills 3 as shown in FIGS. 8A-B. That is to say, the lower slot section 332 preferably has a depth d1 from its entrance to the side edge of the tapered base surface 336 which is greater than 1.5 times the pill diameter pd. Furthermore, the upper slot section 334 preferably has a depth d2 which is less than the pill diameter pd, but greater than the pill width pw. This enables dispensing of the pills 3 to occur while preventing or inhibiting the pills jamming and disabling operation. It allows pills 3 already in the dispensing module 300 to move down the slot 331 even when pills 3 are blocking the entrance 329.

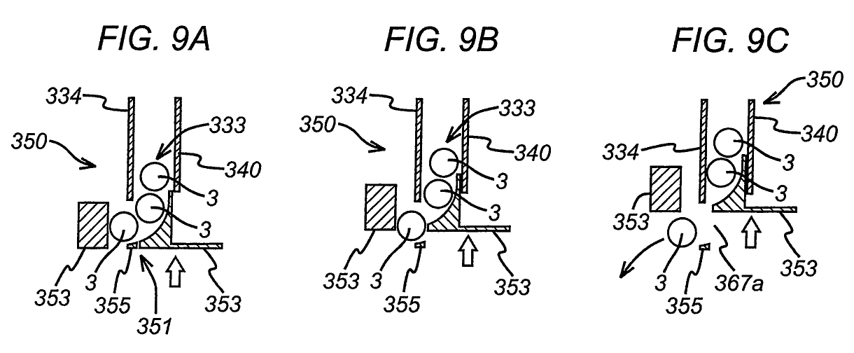

As will now be described with reference to FIGS. 7, 9 and 10, the dispensing module 300 has a dispensing mechanism 350 which is actuable to dispense one pill 3 from the upper opening 311 per actuation. In this embodiment, the nozzle 319 forms the actuator of the dispensing mechanism 350. The dispensing mechanism 350 further has a gate 351 comprising a movable part 353 carried by the lumen 321 of the nozzle 319, and a stationary part 355 in front of the slot 331.

The movable part 353 comprises a first switch member 357 on a first side of the nozzle lumen 321, and a guide member 359 on the opposite side of the nozzle lumen 321. The first switch member 357 is arranged so as to slide over the outer surface of the upper slot section 334 when the nozzle is depressed, whereas the guide member 359 is arranged so as to slide inside the upper slot section 334.

The first switch member 357 has a resilient arm 358 which is biased to an outboard rest state. This is the open state of the first switch member 357. The guide member 359, on the other hand, has a curved guide surface 360 which, in the rest position of the nozzle 319, forms an extension of a side wall 340 of the upper slot section 334 at the outlet end thereof.

As shown in FIG. 7E, for example, the stationary part 355 comprises a side extension 361 of the upper slot section 334 and a finger 363 which extends from the side extension 361 transversely to the slot axis and which is spaced from the outlet end of the upper slot section 334 by a distance at least equal to the pill diameter pd. Moreover, the finger 363 is offset to the slot axis on the same side of the axis as the first switch member 357.

When the nozzle 319 is in its outboard, rest position, the movable and stationary parts 353,355 co-operate to form a barrier across the upper opening 311, i.e. the gate 351 is closed. This is shown in FIGS. 7A, 9A and 10A. More particularly, the guide surface 360 ends adjacent the finger 363 on one side thereof, and the switch arm 358 is in its rest state disposed adjacent the finger 363 on the other side.

As mentioned previously, when the dispenser 1 is inverted, a queue 333 of pills 3 forms in the slot 331. As will be appreciated from FIGS. 7A, 9A and 10A, the pill 3 at the front of the queue (hereinafter the “leading pill”) passes out of the slot 331 and slides down the guide surface 360 and comes to rest on the finger 363 and against the switch arm 358. The other pills 3 in the queue 333 are stacked-up behind the leading pill offset thereto.

As shown in FIGS. 7, 9 and 10, in order to dispense the leading pill 3 of the queue 333 from the dispenser 1, the nozzle 319 is depressed inwardly. This results in the switch and guide members 357,359 moving inwardly. As the first switch member 357 moves inwardly, the switch arm 358 closes through its interaction with the leading pill 3. In this relation, the guide surface 360 may have a camming action which pushes the leading pill 3 sideways against the switch arm 358. Eventually, a gap 367 is formed between the first switch member 357 and the finger 363 large enough for the leading pill 3 to fall out of the nozzle 319 (see FIGS. 7E, 9C and 10C). In other words, the gate 351 has been opened.

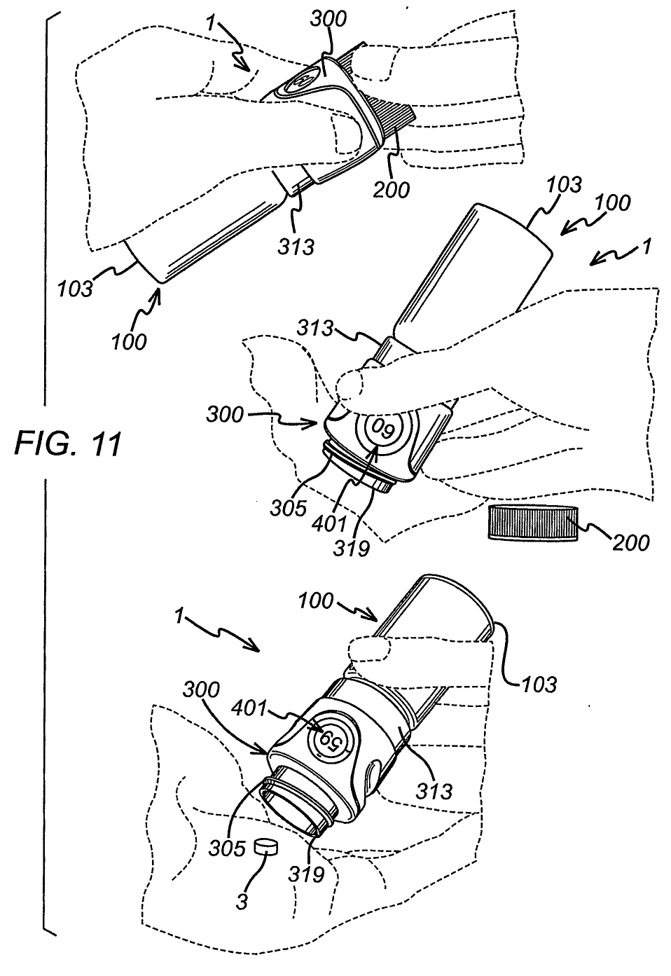

As shown in FIG. 11, a pill 3 can be dispensed in this manner by a user pushing the nozzle 319 into their palm. Such action causes the leading pill 3 to be “blotted” out of the dispenser 1 into the palm as the nozzle 319 is slid inwardly from its rest position to actuate the dispensing mechanism 350. This action is natural and a logical progression from the tipping out of pills from a conventional pill bottle.

As further shown in FIGS. 7D, 7E, 9C and 10C, inward movement of the nozzle 319 not only causes the leading pill 3 to be dispensed, but causes the guide member 359 to push the remaining pills 3 in the queue 333 inwardly as well. This action helps to free pills 3 which would otherwise jam the dispensing module 300.

Return of the nozzle 319 to its rest position closes the gate 351 in preparation for the next dispensing cycle.

It will therefore be understood that the dispenser 1 has a dispensing mechanism 350 which operates to dose one pill 3 from the dispenser 1 per actuation.

From FIG. 5 it will be seen that the dispensing module 300 is formed from an assembly of component parts, predominantly of a plastic material. More particularly, the module 300 has an outer casing 370, which provides the first screw thread profile 317, an inner insert 375, which co-operates with the outer casing 370 to define the funnel-like channel configuration, an outer insert 380 which presents the nozzle 319 and is slidably mountable in the outer casing 370 for sliding movement relative to the inner insert 375, and a collar 385 fixable to the outer casing 370 which presents an aperture 387 behind which the electronic display 401 is disposed.

As shown in FIGS. 2-6 and 11, the dispensing module 300 is further provided with an electronic dose counter 400, having a circular electronic visual display 401, preferably a liquid crystal display (LCD), on which is numerically displayed the number of pills 3 contained in the dispenser 1. After each dispensing cycle, the counter 400 decrements the number displayed on the display 401 by one.

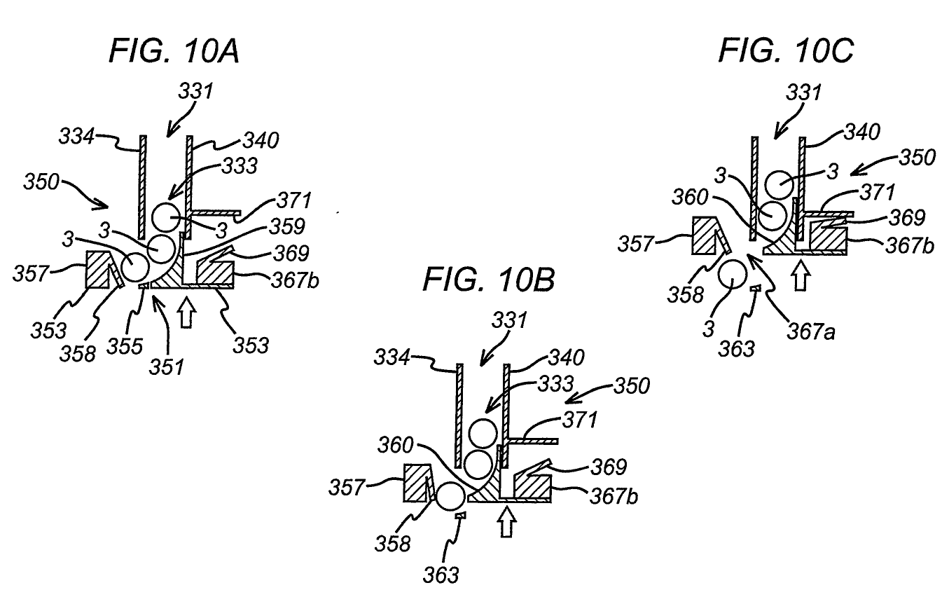

The electronic counter 400 is powered by a battery 402, e.g. a 3 volt CR2016 lithium cell or similar capacity variant, and has a printed circuit board (PCB) 403 on which is mounted a microcontroller (not shown), e.g. an Epson S1C60N16, and other appropriate electronic componentry, as will be understood by the skilled person in the art. The microcontroller is programmed to control the number displayed on the display 401, and in this connection may be connected to the display 401 through an elastomer, such as a flexible heat-seal connector. Moreover, the microcontroller is electrically connected to the first switch member 357 forming part of the gate 351 and also to a second switch member 367 carried by the nozzle 319 (FIGS. 10A-C).

Thus, the microcontroller receives a first electrical input signal when the resilient arm 358 of the first switch member 357 is closed as it interacts with the leading pill 3 as the nozzle 319 is depressed. In other words, the first input signal is indicative that a pill 3 has passed the first switch member 357 and has been dispensed. Alternatively, the first switch member 357 may be configured such that it is closed, and hence produces the first input signal, when the gate 351 is closed. For instance, by the leading pill 3 bearing against the switch arm 358 when the dispenser 1 is inverted.

The second switch member 367 also has a resilient arm 369. The resilient arm 369 of the second switch member 367 is biased to an open position, but when the nozzle 319 is actuated it abuts an internal surface 371 of the nozzle 319 (FIGS. 10A-C) causing it to close. This results in a second electrical input signal being received by the microcontroller, which signal is representative of the nozzle 319 have been depressed a sufficient amount to effect dispensing (i.e. actuated).

Thus, the microcontroller receives two input signals, each independently indicating dispensing. Both signals are required to be received by the microcontroller for it to act to decrement the number on the display 401. This is because the first input signal indicates the presence of a pill 3 (the leading pill) at the gate 351 due to its dependence on a pill triggering the first switch member 357, while the second input signal represents full travel of the nozzle 319 which should ensure dispensing of the pill 3 detected by the first switch member 357. This provides a fail-safe mode of counting.

When the dispenser 1 is first used, the microcontroller is programmed to display the “label claim” of pills contained therein. This may be a factory setting, or set by the prescribing medical practitioner or pharmacist. Each time the dispenser 1 is actuated, and the microcontroller receives the two input signals, which may be required to be simultaneously received or, more likely, sequentially (i.e. the first switch member 357 re-opens before the second switch member 367 closes), perhaps within a specified time period, it operates to cause the electronic display to decrement the number displayed by one. There may also be a requirement that both switches 357,367 need to be re-opened for the microcontroller to update the display 401. That is to say, the microcontroller is programmed or configured such that it will only operate to decrement the count when the two input signals are not only received, but switched-off by the switches re-opening. This adds a further fail-safe.

Of course, the dispenser 1 could be operated with just one of the switch members 357,367. For instance, as represented in FIG. 7, only the first switch member 357 may be included in the dispenser 1.

Eventually, the display 401 will record that no pills 3 are left. In this regard, the microcontroller may be programmed to cause the display 401 to flash when the number of pills left is at or below a predetermined threshold to warn the user that a new supply of pills is, or will shortly be, needed. As an example, the microcontroller may operate to cause the display to flash the number displayed. The display 401 may flash when the number displayed is zero.

In addition to the counter function, the microcontroller and electronic display are also operatively connected such that a ‘time since last dose’ function is displayed by the display 401. This is particularly useful when the pills 3 are pharmaceutical pills.

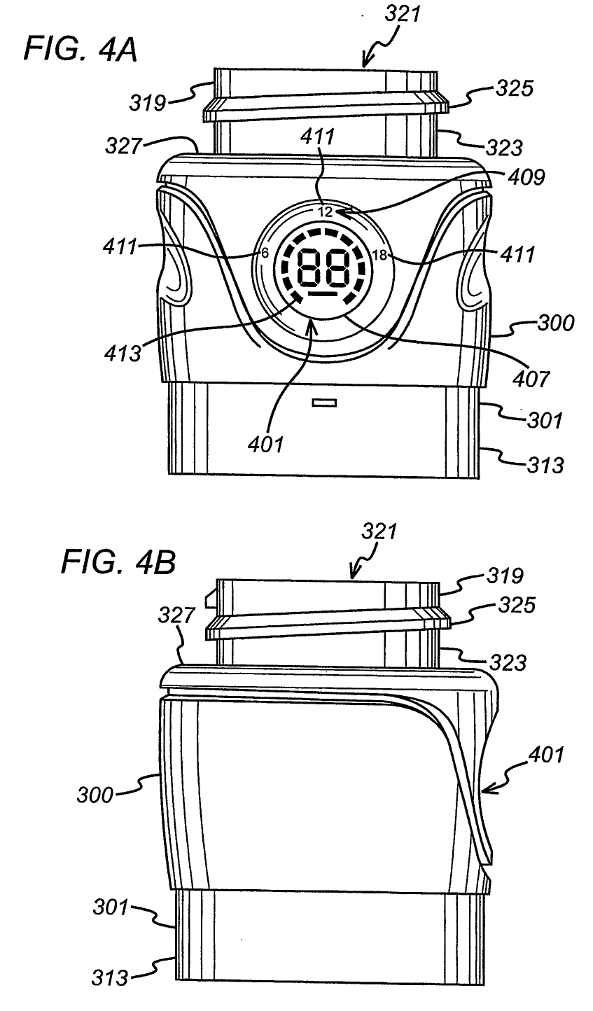

As shown in FIG. 4A, about the circumference 407 of the display 401 there is provided a scale 409 representing the time since a pill was last dispensed, in this instance each section between the adjacent indicia 411 of the scale 409 representing six hour periods, although, of course, other time periods could be represented.

After the microcontroller registers the dispensing of a pill 3 through triggering of the first and second switches 357,367, a timer in the microcontroller is activated and at predetermined intervals thereafter discrete time segments 413 are displayed on the display 401 adjacent the scale 409. In this embodiment each time segment 413 represents two hour periods, although again other time periods could be represented. Thus, after two hours from last dispensing, a first time segment 413 is displayed in the first section of the scale. This is repeated after each further two hour period until another pill is dispensed to re-set the ‘time since last dose’ function. Preferably, as each new time segment 413 is displayed, the previous time segments 413 remain resulting in a time segment chain being formed.

The user of the dispenser 1 will know the dosing regime for the pills 3 (i.e. the time interval between pill taking), either from the prescribing medical practitioner, pharmacist or information leaflet packed with the dispenser 1, and is provided with a visible indication of the time left till the next pill dose is needed, or of the lateness of the next dose. Thus, the dispenser 1 aids in compliance of the user in following the prescribed dosing regime. If need be, the microcontroller can be pre-programmed to cause the display to flash when the time since the last dose corresponds to the prescribed dosing regime, e.g. by flashing the time segments and/or the number of pills left.

A preferred display 401 for the dispenser 1 is shown in FIG. 12. As will be seen, the display 401 is a segmented display, having a plurality of independently activatable segments, including the circumferentially-arranged time segments 413 for the ‘time since last dose’ function. In addition, the display 401 has a pair of seven-segment number-forming display sections 415.

FIGS. 6A-C show the sequence of steps for removing the battery 402 from the dispensing module 300 for replacement with a new battery. More particularly, the battery is held in a battery holder 425 having a recess 427 for accommodating the battery 402. The battery holder 425 is slidably mounted into a slot 429 formed in the tapered side 330 in the cylindrical entrance 329 at the lower module opening 309. To this end, the battery holder 402 has a tapered surface 431 so that, when slid into the slot 429, it sits flush with the tapered side 330. To remove the battery holder 425 to replace the battery 402, a screw driver or other like implement is used to lever the battery holder 425 out of the slot 429.

By enabling the battery 402 to be replaced enables the dispensing module 300 to be re-usable. Nonetheless, the dispensing module 300 may be configured such that the battery 402 is not able to be removed, e.g. in the event the module 300 is designed to be a single-use component which is to be disposed of after use.

For tamper-proofing of the dispenser 1, a label 500 can be wrapped around the dispenser 1 so as to cover the bottle and the dispensing module 300, as shown in FIG. 2. As will be appreciated, if the bottle 100 and dispensing module 300 are disconnected this will damage the label 500 since this bridges the joint between the bottle 100 and the dispensing module 300. This is particularly advantageous where the dispensing module 300 has a re-set button or the like for re-setting the dose counter back to the “label claim” which is only accessible when the module 300 is free of the bottle 100.

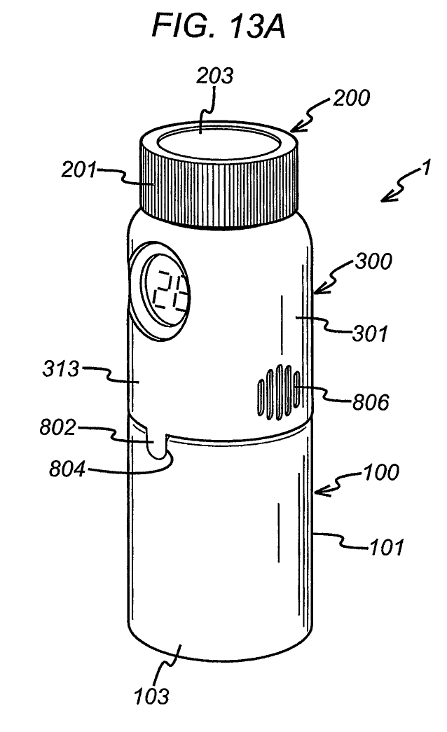

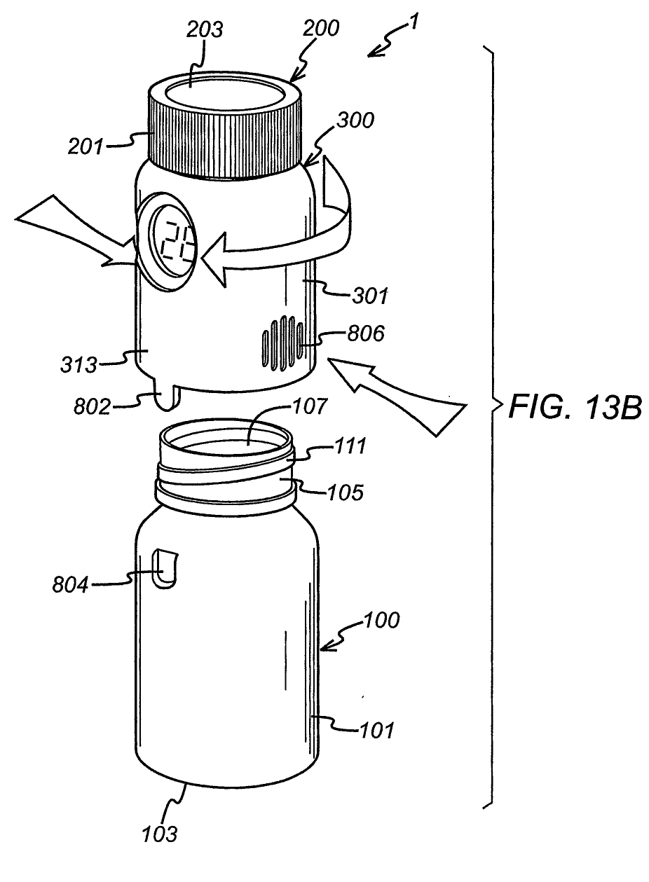

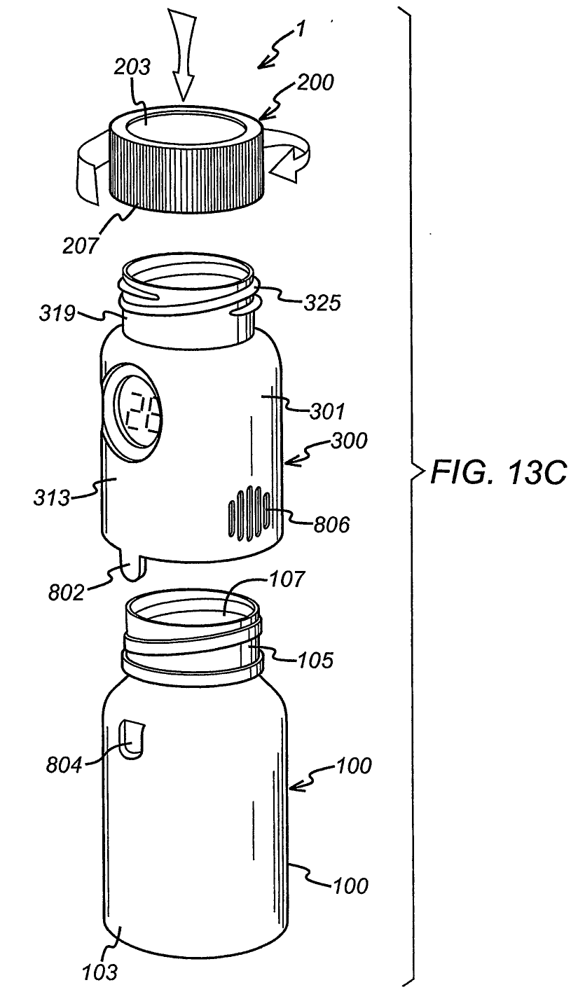

FIGS. 13A-C show a modified version of the dispenser 1 of the previous FIGURES illustrating the operation of child resistant closure (CRC) connections between the dispensing module 300 and the container 100, and the dispensing module 300 and the lid 200. For simplicity, the same reference numerals are used for the same dispenser features.

A child resistant closure (CRC) connection is any type of connection which prevents easy removal of a closure to any type of container (which may include a dispensing module). Generally, easy removal is achieved through unidirectional movement of the closure or container relative to each other so that access to the container is achieved. Unidirectional movement is movement in a single linear or circumferential direction. For example, a closure may comprise a screw thread and can become detached from the container by simply rotating it in one direction. Alternatively, a closure may be a hinged lid which is opened by rotating it about its hinge. Therefore, some types of child resistant connection (CRC) operate by requiring more complex movement of the closure or container in two or more directions.

The annular skirt 313 of the dispensing module comprises a tab 802. The body 301 of the dispensing module 300 is constructed from resilient material such that on application of inwardly directed forces on opposite sides of the body 301, the body 301 flexes outwards at a position 90 degrees about the longitudinal axis of the dispensing module 300 from the points of application of the forces. Hence, if the inwardly directed forces are applied at 90 degrees from the tab 802, the tab 802 will flex outwards. The container 100 comprises a notch 804 into which the tab 802 will fit when the dispensing module 300 is screwed on to the container 100. When the tab 802 is located in the notch 804, rotation of the dispensing module 300 is prevented and the dispensing module 300 is locked to the container 100. By applying inwardly directed forces on each side of the body 301 at 90 degrees from the position of the tab 802, the tab 802 is forced outwards and thereby released from the notch 804 such that the dispensing module 300 can be unscrewed from the neck 105 of the container 100. The tab 802 and notch 804 are dimensioned such that the tab 802 fits into the notch 804 when the dispensing module 300 is screwed down fully onto the container 100. A click may be heard as the tab 802 locks into the notch 804. This type of child resistant closure (CRC) connection can be referred to as a “squeeze-and-turn” connection. Hence, forces in two directions are required to release the dispensing module 300 from the container 100, specifically: (i) an inward radial force on the skirt 313; and (ii) a circumferential force on the body 301 of the dispensing module 300.

At a position 90 degrees around the circumference of the skirt 313 from the tab 802, there may be a disrupted surface 806 which acts as a grip for application of a turning force to the dispensing module 100. The disrupted surface 806 also marks the point at which a user should apply an inwardly directed force. The disrupted surface 806 may be vertical or horizontal parallel grooves formed in the surface of the body 301.

The lid 200 comprises an alternative type of child resistant closure (CRC) connection to that employed between the dispensing module 300 and the container 100. The provision of two different types of child resistant closure connections between the dispensing module 300 and the container 100, and the dispensing module 300 and the lid 200 ensures that the dispensing module 300 is not released from the container 100 as the lid 200 is disengaged from the dispensing module 300, and alternatively that the lid 200 is not released from the dispensing module 300 as the dispensing module 300 is disengaged from the container 100.

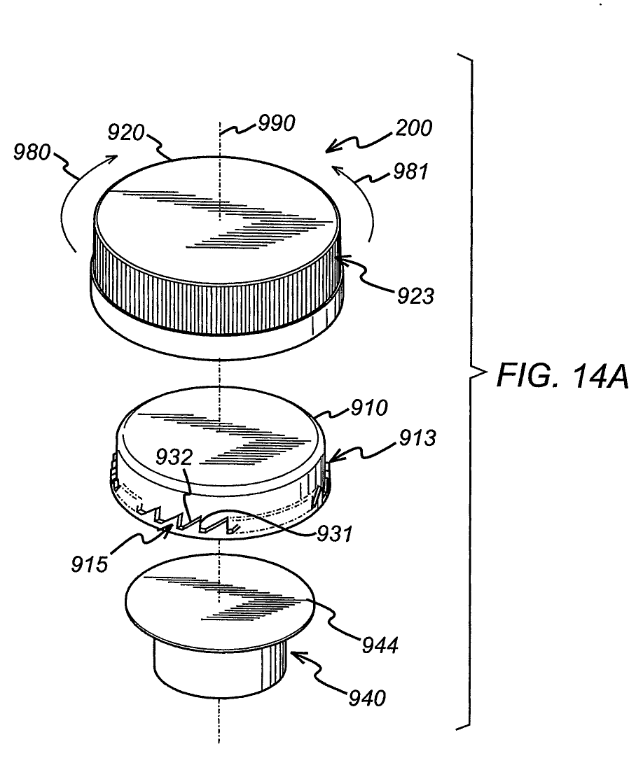

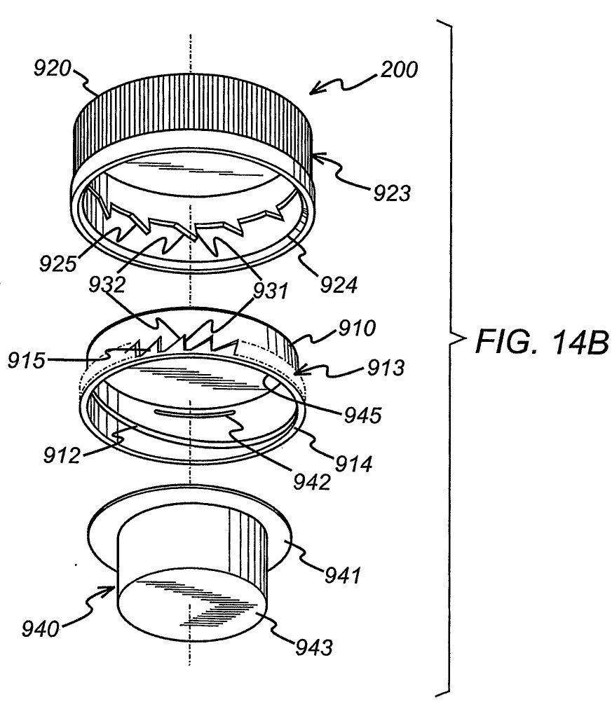

FIGS. 14A and 14B show one type of child resistant closure (CRC) connection employed in the lid 200. The lid 200 comprises an inner connector structure 910 on which a screw thread 912 is formed for engaging with the second screw thread 325 of the dispensing module 300. The inner connector structure 910 is generally free to rotate in one direction in an outer shell 920 of the lid 200 when no vertical force is applied to the cap 200. The outer shell 920 and inner connector structure 910 are formed as separate cup-like components which are mated with each other during manufacture. A first lip 914 around the circumference of an outer surface of the inner connector structure 910 engages with a second lip 924 around an inner surface of the outer shell 920 to hold the inner connector structure 910 within the outer shell 920. The inner connector structure 910 is movable in a vertical direction to a limited extent inside the outer shell 920, but the outer shell 920 is prevented from being removed from the inner connector structure 910 by the presence of the first and second lips 914, 924.

The outer shell 920 and inner connector structure 910 form a clutch mechanism. The clutch mechanism includes first teeth 915 located around the outer circumference of a first side wall 913 of the inner connector structure 910 and second teeth 925 located around the inner circumference of a second side wall 923 of the outer shell 920.

The first and second teeth 915, 925 are saw-tooth shaped with a first engaging edge 931 and a second engaging edge 932. The first engaging edge 931 is arranged vertically with respect to a longitudinal axis 990 of the cap 200 and the second engaging edge 932 is arranged at an angle with respect to the longitudinal axis 990. The angle may be 45 degrees relative to the longitudinal axis 990.

When the first teeth 915 and second teeth 925 are engaged with each other, the inner connector structure 910 is locked to the outer shell 920 such that rotation of the outer shell 920 in a clockwise direction 980 rotates both the outer shell 920 and inner connector structure 910 because the first engaging edge 931 of each of the second teeth 925 engages with a corresponding first engaging edge 932 of each of the first teeth 915. This way, the cap can be secured to the dispensing module 300 by rotating the outer shell 920 in a clockwise direction so that rotational force is transmitted to the inner connector structure 910 through the first engaging edges 931, thereby permitting the inner connector structure 910 to be screwed on to the dispensing module 300. Rotation of the outer shell 920 in an anti-clockwise direction 981 whilst the inner connector structure 910 is screwed on to the dispensing module 300 will cause the second engaging edges 932 of both the outer shell 920 and inner connector structure 910 to move over each other because these edges are at an angle with respect to the longitudinal axis 990. This way the outer shell 920 is not locked to the inner connector structure 910 and therefore the inner connector structure 910 cannot be unscrewed from the dispensing module 300. However, when a vertical force is applied in a direction along the longitudinal axis 990 towards the dispensing module 300, the friction force between the second engaging edges 932 of the inner connector structure 910 and outer shell 920 increases. Thus, when a vertical force is applied to the outer shell 920 at the same time as an anticlockwise rotational force, the second engaging edges 932 do not move over each other as a result of this increased friction and hence the inner connector structure 910 and outer shell 920 remain locked to each other and the inner connector structure 910 becomes unscrewed from the dispensing module 300.

The cap 200 further comprises a boss 940 which comprises a lip 941. The lip 941 is dimensioned so that the boss 940 can be inserted during manufacture into the inside of the inner connector structure 910 and is then held in place by a ridge 942 located on the inner surface of the first side wall 913 of the inner connector structure 910. The boss 940 is free to rotate relative to the inner connector structure 910. On application of a vertical force to the outer shell 920 towards the dispensing module 300, a lower surface 943 of the boss 940 engages with the finger 363 in the nozzle 321 of the dispensing module 300. Thus, an upper surface 944 of the boss 940 is forced against an end wall 945 on the inside of the inner connector structure 910 to force the first teeth 915 of the inner connector structure 910 to engage the second teeth 925 of the outer shell 920 and ensure that the second engaging surfaces 932 of the outer shell 920 and inner connector structure 910 are forced together. This way, the reaction force to a vertical force applied to the cap 920 is not transmitted via the screw thread 912 which would increase the frictional force in the thread and hinder removal of the cap 200 from the dispensing module 300.

This type of child resistant closure (CRC) connection can be referred to as a “push-and-turn” connection. Hence, forces in two directions are required to release the dispensing module 300 from the container 100, specifically: (i) a downward axial force on the end wall 203; and (ii) a circumferential force on the skirt 201.

The screw thread on the inner connector structure of the lid 200 is dimensioned to fit the screw thread on the neck 105 of the container 100 so that the lid 200 can be used as a child resistant closure (CRC) for the container 100. In this regard, reference to the dispensing module 300 in the aforementioned description of FIG. 14 should be replaced with a reference to the container 100.

It will, of course, be appreciated that many different types of child resistant closure can be used with the dispensing module 300, lid 200 and container 100. By using child resistant closures in which movement in two directions is required for disengagement and having at least one direction of movement that is different in each closure, then disengagement of one connection, whilst the other connection is being disengaged, can be prevented.

It will appreciated that the invention is not limited to the exemplary embodiments herein described with reference to the accompanying FIGURES of drawings, but may be modified, varied and adopt other guises within the scope of the appended claims.

What is claimed is:

1. A hand-held dispenser for dispensing a multiplicity of unit products having a storage area for storing the unit products, an outlet opening through which the unit products are dispensable from the dispenser, a dispensing mechanism actuable to dispense the unit products through the outlet opening, and a dispensing indicator for indicating the number of unit products left in, or dispensed from, the dispenser, the dispensing indicator being integrated with the dispenser such that it is automatically updated in response to the dispensing of the unit products therefrom.

2. The dispenser of claim 1 in which the dispensing indicator has a display to indicate the number of unit products left or dispensed.

3. The dispenser of claim 2 in which the dispensing indicator is adapted to represent the number of unit products left or remaining in graphical form on the display.

4. The dispenser of claim 3 in which the number of unit products is represented with numerical indicia.

5. The dispenser of claim 2 in which the display is an electronic display.

6. The dispenser of claim 1 wherein the dispensing indicator is an electronic indicator.

7. The dispenser of claim 1 in which the dispensing indicator is a dispensing counter.

8. The dispenser of claim 1 wherein the dispensing indicator is operatively coupled to the dispensing mechanism such that the indicator is updated in response to actuation of the dispensing mechanism.

9. The dispenser of claim 8 in which the dispensing indicator is operatively coupled to the dispensing mechanism through a detector which is adapted to detect actuation of the dispensing mechanism.

10. The dispenser of claim 1 wherein the dispensing mechanism is operatively coupled to a detector, which is adapted to detect dispensing of unit products from the outlet opening, such that the dispensing indicator is updated in response to detection by the detector of dispensing of unit products from the outlet opening.

11. The dispenser of claim 9 in which the display is an electronic display wherein the dispensing indicator has an electrical control circuit for controlling the display and the detector(s) is a trigger(s) for the circuit.

12. The dispenser of claim 11 wherein the trigger(s) is a switch operable to trigger the circuit.

13. The dispenser of claim 12 in which the dispensing indicator is operatively coupled to the dispensing mechanism through a detector which is adapted to detect actuation of the dispensing mechanism, and wherein the dispensing mechanism is adapted to operate the switch when actuated.

14. The dispenser of claim 12 wherein the dispensing mechanism is operatively coupled to a detector, which is adapted to detect dispensing of unit products from the outlet opening, such that the dispensing indicator is updated in response to detection by the detector of dispensing of unit products from the outlet opening, and wherein the switch is positioned so as to be operated by the unit product(s).

15. The dispenser of claim 1 having the unit products.

16. The dispenser of claim 15 wherein the unit products are pharmaceutical products.

17. The dispenser of claim 16 wherein the pharmaceutical products are oral dosage forms.

18. The dispenser of claim 15 wherein the unit products are pills.

19. The dispenser of claim 1 in which the dispensing mechanism is adapted to dispense a predetermined number of unit products per actuation.

20. The dispenser of claim 19 wherein the predetermined number is one.

21. The dispenser of claim 1 wherein the storage area is provided in a first dispenser part and the dispensing indicator and outlet opening are provided in a second dispenser part attached to the first dispenser part.

22. The dispenser of claim 21 wherein the dispensing mechanism is provided in the second dispenser part.

23. The dispenser of claim 21 wherein the first and second dispenser parts are releasably attached.

24. The dispenser of claim 21 wherein the first dispenser part has an access opening through which the unit products are transferable from the storage area into the second dispenser part and the dispenser has a closure which is selectively connectable with the first and second dispenser parts to respectively close the access opening and the outlet opening.

25. The dispenser of claim 24 wherein the closure is a cap.

26. The dispenser of claim 24 wherein the closure, on the one hand, and the first and second dispenser parts, on the other hand, have co-operable connecting structures for selectively connecting the closure to the first and second dispenser parts.

27. The dispenser of claim 26 wherein the connecting structures on the first and second dispenser parts are the same.

28. The dispenser of claim 26 wherein the second dispenser part has a further connecting structure which is co-operable with the connecting structure of the first dispenser part which co-operates with the connecting structure of the closure to enable connection of the first and second dispenser parts.

29. A dispensing module for attachment to a container for a multiplicity of unit products in the form of the second dispenser part of claim 22.

30. (canceled)

31. (canceled)
